(19) United States
(12) Patent Application Publication
(10) Pub. No.: US 2006/0043175 A1
(43) Pub. Date: Mar. 2, 2006

(54) Mobile banking and anti-theft tag based smart portable checkout terminal, system, and method thereof

(75) Inventors: Rong Yao Fu, Beijing (CN); James Tien-Cheng Yeh, Beijing (CN)

Correspondence Address: IBM CORPORATION, PO BOX 12195, DEPT YXSA, BLDG 002, RESEARCH TRIANGLE PARK, NC, 27709, US

(73) Assignee: International Business Machines Corporation, Armonk, NY (US)

(21) Appl. No.: 11/213,546

(22) Filed: Aug. 26, 2005

(30) Foreign Application Priority Data
Aug. 27, 2004 (CN) 2004100685039

(51) Int. Cl. G06K 15/00

(52) U.S. Cl. 235/383

(57) ABSTRACT

A mobile banking and anti-theft tag based portable checkout terminal, checkout system and checkout method for a retail environment are disclosed. A portable terminal accessory is designed for a portable terminal to acquire the article information related to the selected article that a customer in a retail environment wishes to purchase. The portable terminal is connected to the portable terminal accessory to receive the article information via scanning a tag attached to the article and to conduct the checkout processing with a customers bank through wireless communication.

### BACKGROUND OF THE INVENTION

1. Field of the Invention

The present invention generally relates to a checkout system used in retail establishments. More particularly, the present invention relates to a mobile banking and anti-theft tag based smart portable checkout terminal and a checkout system for the retail establishments using the mobile banking and anti-theft tag based smart portable checkout terminal.

2. Description of the Related Art

Retail establishments are trying to become more efficient by applying different and innovative operating techniques that help to increase their business's financial condition. One of the constantly pursued goals is the reduction of a customer's waiting time in a checkout line. Being able to speed up the flow of customers through a check-out station, or to reduce cost of a checkout transaction, is critical to the success of a retail business. The introduction of bar codes was an evolution of the store checkout process, which caused replacement of manual price keying of each item being purchased. This process permitted the scanning the bar code of each item by a POS (Point of Sale) machine having a bar code reader and the calculating of the total costs automatically. Today, bar codes and bar code readers are widely used in commercial and retail environments.

However, for POS systems which use a bar code reader, the customer has to present all the items he (she) wants to purchase to the cashier at a checkout register, and the cashier scans each item in the order in which it is presented to him. After all the items have been scanned, the total cost which the customer should is automatically calculated.

Even though scanning all the items at a checkout register and calculating automatically the total cost take much less time than manually entering each item and seldom results in mistakes, the sequential presentation to a cashier of each individual item being purchases can take a long time and create long lines of customers waiting to pay for their purchases. This can cause bottlenecks at the checkout station, make customers unsatisfied, reduce throughput, and adversely affect the financial condition of a retail establishment.

In order to overcome the above problem, there have been proposed and developed many self-checkout systems in for retail use. U.S. Pat. No. 6,687,346, which issued on Feb. 3, 2004, describes a self-checkout system for a retail shopping environment. The system uses a portable communication terminal comprising a scanning device for communication with the store's host computer to accomplish the checkout. The system comprises a plurality of portable communication terminals, a store's host computer, and a plurality of store checkout station. Each portable communication terminal, which includes a bar code reading module and a telephone module, is leased or owned by the consumer using it, or made available to the consumer by the telephone network service provider. Therefore, the portable communication terminal may function as a cellular telephone, a modulator-demodulator or personal handset scanning terminal. When the portable communication terminal is used as a personal handset scanning terminal, the consumer can use it to scan the bar code on articles which he (she) wants to purchase, and then on the display of the portable communication terminal displays the shopping list and individual article price.

When the above self-checkout system is used to perform transaction in retail store, a consumer, upon entering a retail store, establishes a cellular communication channel between his portable communication terminal and the store's host computer. While shopping, the customer scans each product he wants to purchase. The bar code information of the scanned item is transmitted to the store computer via the established communication channel. The store host computer, upon receipt of the bar code information, updates the customer's transaction list file and sends product information, product price, and customer's subtotal amount spent, back to the terminal. After the item selection has been finished and the customer goes to a checkout register, the cashier at the checkout register checks the products in customer's basket with the transaction list file stored in the host computer one by one. After successful security verification of the purchased items, the final bill is calculated. After paying the bill, the customer terminates the communication channel between portable communication terminal and the store host computer.

However, including a scanning module in every portable communication terminal would increase the cost of the portable communication terminal to the customer. But due to different protocols in stores' sales systems, it may be difficult for a customer to use the same portable communication terminal to shop in different stores. If the computer and communication system of a store must be reconfigured so as to be able to communicate with the portable communication terminals which use difficult protocols, this would be a large expense for the retail store, and possibly a prohibitive expense for median or small scale stores. Furthermore, if the transaction is performed depending on the customer using his portable communication terminal to scan the bar code on the products and on the cashier checking the list, the product theft problem is still not solved effectively.

Additionally, although the checkout system described above can in part mitigate the waiting time for the customer, when there are many customers and the customers have purchased a substantial number of products, the checking of the transaction list can cause long lines of customers waiting to pay for their purchases as well as increase the risk of product theft. Therefore, it can be said that the checkout system performing transaction by using a portable communication terminal comprising a scanning device to communicate with the host computer of the store, as disclosed in U.S. Pat. No. 6,687,346 described above, is one of the half self-service system, not to be considered as a full self-service checkout system in a real sense.

Taking aim at the above problem, many development and research units have focused their attention on developing a smart checkout system or full self-checkout system based on automatic recognition and E-payment. These attempts have obtained certain success. Among others, one of the most practical and successful solution uses radio frequency identification (RFID) tags to monitor the goods in customer's shopping basket via an antenna when he is shopping in a retail establishment. In this solution, the RFID reader picks up the tags information in customer's shopping basket, a POS machine automatically displays an item list of goods which the customer purchases, and then the customer confirms the list, pays the bill, and the POS machine prints a receipt.

Although this solution implements a basic full self-shopping environment, this smart checkout system still has many problems to be solved, such as the cost of a long range RFID tag being too expensive, the investment of a POS machine being too high, etc. In addition, this solution is not yet a good solution to solve the security problem caused by goods theft and credit card theft.

### SUMMARY OF THE INVENTION

In view of the problem described above, an object of the present invention is to provide a smart portable checkout terminal based on mobile banking and anti-theft tag, which is secure, reliable, low cost, and unnecessary to reconstruct the existing checkout system in large scale, a checkout system associated with the mobile banking and anti-theft tag based smart portable checkout terminal for retail establishment, and a checkout method including the computer program and recording medium thereof for the retail establishment using the smart portable checkout terminal based on mobile banking and anti-theft tag, such that allows customers to use their own portable terminal pick up goods information and conduct payments through bank services provided to his portable terminal, thereby a self checkout system can be implemented in retail establishment.

According to one respect of the invention, there is provided a smart checkout system based on mobile banking and anti-theft tag, the smart checkout system is characterized by including: a mobile banking system for processing transaction through wireless communication; portable terminal accessory for acquiring product information related to the selected product; and a portable terminal connected to the portable terminal accessory for receiving said product information and for checkout processing with the mobile banking through wireless communication.

According to another respect of the invention, there is provided a portable checkout terminal based on mobile banking and anti-theft tag, the portable checkout terminal is characterized by including: portable terminal accessory for acquiring product information related to the selected product; and a portable terminal connected to the portable terminal accessory for receiving said product information and for checkout processing with the mobile banking through wireless communication.

According to a further respect of the invention, there is provided a portable terminal accessory for using in the mobile banking and anti-theft tag based portable terminal to perform checkout processing in retail product shopping, the portable terminal accessory is characterized in that said product is attached with an integrated security tag containing a bar code, wherein said portable terminal accessory includes: a processor for providing control and calculation functions to the portable terminal accessory; a bar code scanner for reading the bar code attached to the integrated security tag and transmitting it to the processor; a portable terminal connector interface connected to the portable terminal bottom connector for powering the portable terminal accessory and communicating with the serial port of the portable terminal; and a portable terminal accessory controller for communicating with the running checkout control application on the portable terminal, and driving the portable terminal accessory to work harmoniously with the portable terminal to complete the checkout processing.

According to another respect of the invention, there is also provided a checkout method based on the mobile banking and anti-theft tag, the checkout method is characterized by including the steps: acquiring product information related to the selected product; and performing self automatic checkout processing between the customer and the mobile banking by the customer himself through wireless communication, without the store worker's participation.

According to a further respect of the invention, there is also provided a program for driving the portable terminal to execute the product checkout processing based on the mobile banking and anti-theft tag, characterized in that said program includes the steps: acquiring product information related to the selected product; and performing self automatic checkout processing between the customer and the mobile banking by the customer himself through wireless communication, without the store worker's participation.

The invention furthermore provides a storage media for recording the program described above for driving the portable terminal to execute the product checkout processing based on the mobile banking and anti-theft tag.

In the checkout system and the method described above according to the invention, for the purpose of reducing the lost of merchants due to goods theft, a tag with anti-theft function is applied.

According to the smart portable checkout terminal based on mobile banking and anti-theft tag, the smart checkout system based on mobile banking and anti-theft tag, the checkout system associated with the mobile banking and anti-theft tag based smart portable checkout terminal for retail establishment, and the checkout method for the retail establishment using the smart portable checkout terminal based on mobile banking and anti-theft tag, the portable terminal accessory combines functions of bar code scanner and anti-theft tag deactivation/reactivation, and works harmoniously with bank services provided to the portable terminal, thereby conducts the basic actions of goods purchases: pick up goods information, make payment, mark goods paid.

Employing the checkout system and the checkout method according to the invention described above, customers can conduct the checkout processing at any place inside the shopping area in the retail store, thus the waiting time of customers is greatly reduced. In addition, because most of the retail payments can be paid via the portable terminal instead of POS machine, therefore the investment for the POS machine and labor cost is reduced. Also, the said checkout system and said checkout method according to the invention use customer's portable terminal as a customer terminal and make it supporting the short-range anti-theft tag, thus the investments from the store owner to the checkout system is greatly reduced.

Furthermore, because the most secure and reliable mobile banking is employed as the E-payment system, the transaction security between customer and the retail establishment is guaranteed.

Other objects, features and advantages of the present invention will become more apparent after reading the following description of the preferred embodiments.

### BRIEF DESCRIPTION OF THE DRAWINGS

The accompanying drawings, which are incorporated in and constitute a part of the specification, illustrate the embodiments of the present invention and, together with the description, serve to explain the principles of the present invention. In the drawings:

FIG. 1 is a schematic diagram showing the self-service smart checkout system according to the invention;

FIG. 2 is a block diagram showing the architecture of the portable terminal accessory according to the invention;

FIG. 3 is a flowchart schematically showing the process of the self checkout executed by the portable terminal accessory in retail according to the invention;

FIG. 4 is a flowchart schematically showing the process of the self checkout executed by the portable terminal in retail according to the invention; and

FIG. 5 is an example of applying the device having portable terminal accessory's functions onto the shopping cart.

### DESCRIPTION OF THE PREFERRED EMBODIMENTS

The preferred implementation of the present invention will now be described in detail with reference to the accompanying drawings as follows.

Following world trends in the development and spread of mobile banking, in today's business environment, most banks have begun to offer mobile banking service. Now one can access his/her account, conduct an account inquiry and carry out a banking transaction from the portable terminal, thereby realizing true “anywhere, anytime, anyhow” convenience. As the mobile payments infrastructure is optimized for large numbers of small payments, it is therefore feasible for banks to handle the retail payment checkouts.

For a typical mobile banking solution, the SIM card in a portable terminal is pre-loaded with the appropriate keys, as well as a SIM Application Toolkit (SAT) based banking application. The SAT application interacts with the portable terminal through standard SIM commands, and the transaction data is encrypted within the SIM card before being sent to the backend.

For all retailers, regardless of size, inventory theft is a significant problem. Such theft costs the industry more than $32 billion in lost profits each year alone. Anti-theft systems, including anti-theft tag and alarm systems, are strong, proven deterrents against would-be shoplifters. There are currently three tag and alarm systems on the market today: the electromagnetic (EM) system, the radio frequency (RF) system and the acoustic-magnetic (AM) system. An anti-theft tag which when attached to an article transmits a signal to a control device to release an alarm signal at the store exit area if the article has been taken without permission.

One tiny, easy to apply label is the fully integrated bar code label. The label includes an EM security strip on the adhesive white backing. When one person scans the bar code using a combination scanner, the security strip becomes deactivated in one single, swift movement. The following description of the preferred implementation of the invention applies the EM system and the integrated security bar code label as an example. Of course, the invention is not limited to this example, but may be applied to any other type of anti-theft tag and alarm system which has a similar function.

Further, as mobile communication technology continues to develop, today, the portable terminals produced by every manufacturer offer convenient connection with different accessories that enhance and extend the application functions of the portable terminals. The bottom connector of the portable terminal is designed in such a way that a supply voltage can be fed out for powering accessories and software applications are able to switch on the accessory power. The serial interface of the bottom connector includes full-duplex signals for transmitting and receiving serial data between the accessory and the portable terminal. With the application programming interface (API) provided by the portable terminal operating system (OS), software applications are able to control the power of accessories and conduct communication between accessories and the portable terminal.

The portable terminal accessory according to the invention combines the functions of bar code scanning and anti-theft tag deactivation/reactivation. With the Payment Control Application (PCA) according to the invention, the portable terminal accessory will work harmoniously with bank services provided to the portable terminal, conducting the basic action of the goods purchase by full service, including picking up goods information, making payment and marking goods paid. The PCA provides a user interface that guides the end user/customer through the entire process of article purchase and payment. After receiving end user's instruction, the PCA switches on the portable terminal accessory and drives the accessory which scans a bar code printed on an article label. The PCA then displays the article information on the portable terminal screen to the end user. When the user confirms the purchase of the article, the PCA invokes the banking services from the SIM card to conduct the payment process. At the end point of the payment, the PCA drives the portable terminal accessory to rescan the bar code on the article label and deactivate the security strip in a single, swift movement.

The PCA mentioned above can be installed into the portable terminal in several ways, for example, by the portable terminal accessory, the operator, the retailer or the end user and the like. The end users can install the PCA to their own portable terminal using an over-the-air (OTA) service provided by the WAP (Wireless Application Protocol).

The portable terminal accessory as described above according to the invention, the checkout system for the retail establishments using the mobile banking and anti-theft tag based smart portable checkout terminal, and the checkout method for the retail establishments using the mobile banking and anti-theft tag based smart portable checkout terminal will be described in detail in conjunction with the accompanying drawings below.

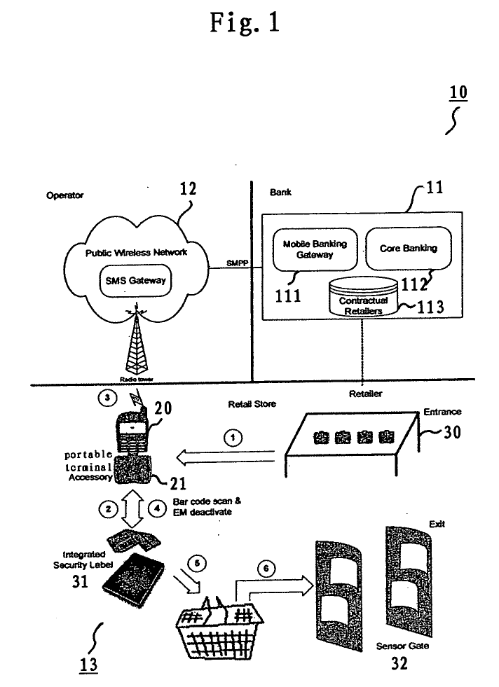

FIG. 1 is a schematic diagram showing the self-service smart checkout system according to the invention. As shown in FIG. 1, a smart checkout system 10 primarily includes a mobile banking system 11, a tag and alarm system 13, and a portable smart checkout terminal 20. The portable smart check terminal 20 includes the portable terminal accessory 21 described above. When the customer enters a retail store through a store entrance 30, he is provided with a portable terminal accessory 21 which will function with his portable terminal 20 (which may be, for example, his mobile phone) by the store administration. The customer connects the portable terminal accessory 21 with his portable terminal 20. Then, during shopping, he scans the bar code of the integrated label attached to an article, using the scanner contained in the portable terminal accessory 21, and reads the article information displayed on the portable terminal 20. After confirming the desire to purchase the article that he selected, the portable terminal 20 connects to mobile banking via the common wireless network to complete the payment process for the article. After that, the customer rescans the paid article to complete the checkout process, at which time, the hidden security strip is deactivated. When the customer has finished shopping, the customer brings the purchased goods through a sensor gate installed at the store exit. Since the security strips have been deactivated, no alarm sounds and the customer exits the store not having had to wait in any checkout line.

In addition, the customer may print a purchase receipt and/or invoice at a convenience printer located in the store at a convenient time.

It is apparent from the purchase process described above that customers can conduct the entire purchase process by themselves through their portable terminal, without waiting for make payment in a check out line. Thus, the retail store need not provide special checkout stations and cashiers. As a result, customer shopping time is reduced. Also, the store's capital and operating expenses are also reduced, since fewer employees and less space is required, and the need for check equipment and stations can be eliminated. At the same time, the security of goods is enhanced.

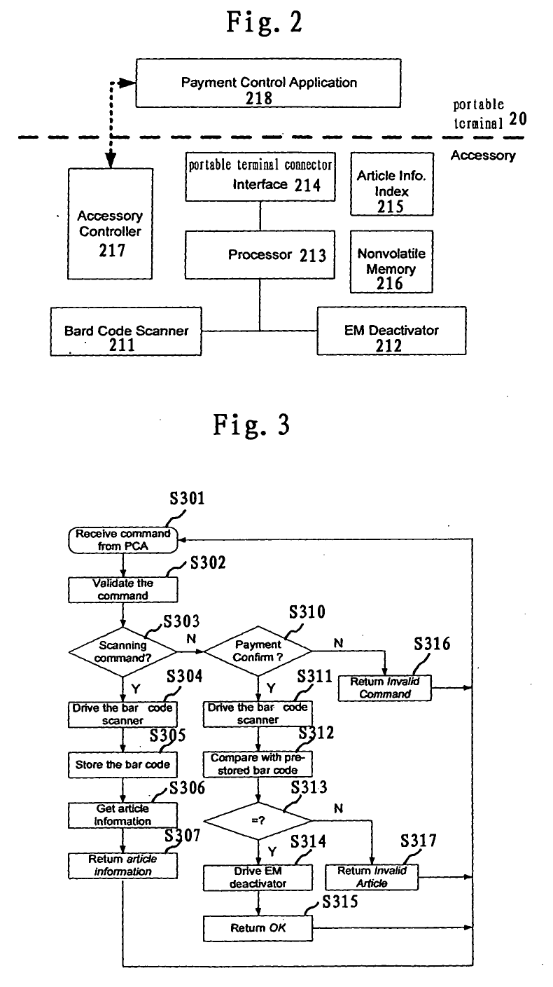

The key component or the portable terminal accessory 21 according to the invention will be described in detail in conjunction with FIG. 2 below. As shown in FIG. 2, the portable terminal accessory 21 according to the invention primarily includes a bar code scanner 211, an EM deactivator 212, a processor 213, a connector interface 214 of the portable terminal, an accessory controller 217 of the portable terminal, an article information index 215, and a nonvolatile memory 216.

The bar code scanner 211 is used to read the bar code of the integrated security label, and sends the data from the bar code to the processor 213. The EM deactivator 212 is used to deactivate the hidden security strip in the integrated security label after the mobile banking system has finished processing the payment. The processor 213 provides control and computing capabilities for the entire portable terminal accessory 21. The connector interface 214 of the portable terminal is connected to the bottom connector to provide serial port communication for the portable terminal accessory 21 with the customer's portable terminal 20, and also connected to the power supply. The accessory controller 217 is used to communicate with the payment control application 218 which runs on the portable terminal 20, and to drive the portable terminal accessory 21 to work harmoniously with the portable terminal 20 to finish the self checkout process. The article information index 215 provides a data service that maps a bar code into article information. The nonvolatile memory 216 holds retailer information and stores temporary information generated during a shopping process.

FIG. 3 is a flowchart schematically showing the workflow of the portable terminal accessory 21 when a customer his/her portable terminal 20 with the portable terminal accessory 21 to purchase an article in a retail store. The accessory controller 217 of the portable terminal communicates with the payment control application (PCA) 218 which runs on the portable terminal 20 in a “command-response” way. That is, the portable terminal accessory 21 receives commands from the PCA 218, executes the appropriate operations and returns the results to the PCA 218.

As shown in FIG. 3, at step S301, the portable terminal accessory 21 initially receives a command from the PCA 218. Then at step S302, the portable terminal accessory 21 validates the command received from PCA 218. Subsequently, at step S303, the portable terminal accessory 21 judges whether the command received from the PCA 218 is a scanning command. If the received command is a scanning command, then at step S304 the bar code scanner 211 is driven to scan the bar code attached to the integrated security tag on the selected article by the customer. After that, at step S305, the bar code data scanned at step S304 is stored in the nonvolatile memory 216, and at step S306, based on the scanned bar code data, the article information corresponding to the bar code data is retrieved from the article information index 215. Then at step S307, the article information obtained at step S306 is returned to the PCA 218, and the workflow proceeds back to step S301, waiting for a command from the PCA 218.

If at step S303, it is determined that the command received from the PCA 218 is not a scanning command, the workflow proceeds to step S310. At step S310, it is judged whether the command received from the PCA 218 is a payment command. If the received command is a payment confirming command ordered by the customer, then at step S311, the bar code scanner 211 is driven to scan the bar code attached to the integrated security tag on the selected article. Then, at step S312, the bar code data scanned at step S311 is compared with the bar code data contemporarily stored in the nonvolatile memory 216 at step 305 which was obtained at the first scanning, and at step S313, it is judged whether the bar code data obtained at the first scanning is consistent with the bar code data obtained at the second scanning. If the two are the same, indicating that the article has been selected and the payment successfully processed, processing proceeds to step S314.

At step S314, the accessory 21 is driven to drive the EM deactivator to deactivate the hidden security strip in the integrated security label. Then at step S315, a message that the transaction has been successfully completed is returned to the PCA 218. At that point, the purchase of that article is finished, the customer can select another article again and repeat the purchase process described herein.

In step S313, if it is determined that the bar code data obtained in the first scanning of step S304 is not consistent with the bar code data obtained in the second scanning of step S312, this is an indication that the two articles scanned are not the same, and that a mistake or error of some type has been made. The purchase attempt is deemed to have failed for the scanned article(s). At step S317, a message indicating that there was an error and no payment should be processed is returned to the PCA 218. Processing then returns to step S301 and a new command from the PCA 218 is awaited. At that point, the customer can select another article and begin the purchase process described herein for the selected article.

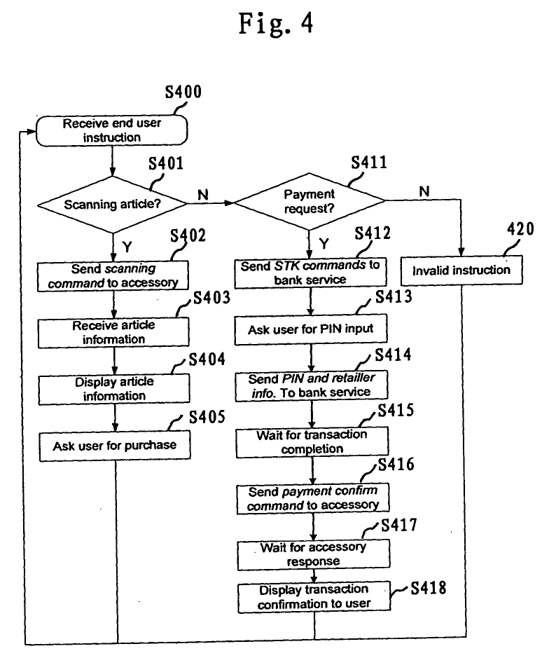

The above description describes the workflow or process carried out by the portable terminal accessory 21 when a customer is shopping. Next, the workflow conducted by the portable terminal 20 when the customer makes payment for an article will described with reference to FIG. 4. The process illustrated in FIG. 4 is conducted and finished under the control of the PCA 218. Generally, the PCA 218 is supplied by the retailer and runs on the customer's portable terminal 20, such as a mobile phone. The PCA 218 allows the portable terminal accessory 21 to work harmoniously with a bank service through the user's portable terminal, conducting the self-payment process during shopping in a retail store. Furthermore, the PCA 218 also provides a user interface that guides the end user/customer through the process of article purchase and payment. FIG. 4 shows the workflow of the PCA 218.

As shown in FIG. 4, at step S400 the process begins when the PCA 218 receives an instruction from the end user/customer. Then at step S401, the PCA 218 determines whether the instruction received from the end user is to scan an article. If the received instruction is to scan an article, then at step S402, the PCA 218 sends a scanning command to the portable terminal accessory 21, and waits for the scanning result to be returned from the portable terminal accessory 21.

At step S403, the PCA 218 receives the article information for the customer's selected and now scanned article from the portable terminal accessory 21. In step S404, the PCA 218 displays the article information on the screen of the portable terminal 20. This may include various data of interest to the consumer, such as price and other article information. Next, at step S405, the PCA 218 asks the customer, via a message on the screen, whether purchase of the article is desired. Processing then returns to step S400 to await a new instruction, such as a request to scan a new article or a request to purchase the previously selected article.

If at step S401, it is determined that the command received from the end user is not a command to scan the article, the process proceeds to step S411. At step S411, a judgement is made as to whether the command sent from the user is a payment request for the purchase of the article. If not, a message that the sent instruction is an invalid instruction is displayed on the screen of the portable terminal 20 in Step 420. Then returns to step S400, waiting for a next instruction from the end user, and the PCA 218, stops waiting for a purchase request for the previously scanned article.

If at step S411, it is determined that the instruction sent from the user is a payment request for purchasing the article, then at step S412, an STK command is sent to the mobile banking service provider. After that, at step S413, the user is asked to input his/her PIN (Personal Identification Number), and at step S414, the input PIN and the information related to the retailer are sent to the mobile banking service provider to process payment for the selected article.

It should be noted that the user's PIN may be stored in advance in the portable terminal 20, so as to prevent the user from having to input his/her PIN for each article being purchased and reduce user error. In this case, at step S414, the stored user's PIN beforehand and the information related to the retailer are sent together to the mobile banking service provider.

Next, at step S415, the process waits for the mobile banking service provider to complete the transaction. Upon receiving information from the service provider that the payment transaction has been completed, a payment confirmation command is sent to the portable terminal accessory 21 at step S416. At step S417, the process waits for a response from the portable terminal accessory 21.

After receiving the response from the portable terminal accessory 21, at step S418, the portable terminal displays a transaction confirmation message to the user. At this point, the selection of and payment for the article is finished. The processing flow returns to step S400, where it awaits the selection of a new article selection and receipt of a new command.

In the above description, the portable terminal accessory 21 is a detached unit which is provided to the customer when he enters the store. The portable terminal accessory 21 is connected to customer's portable terminal 20, and the combined unit is employed to conduct the subsequent shopping and payment process.

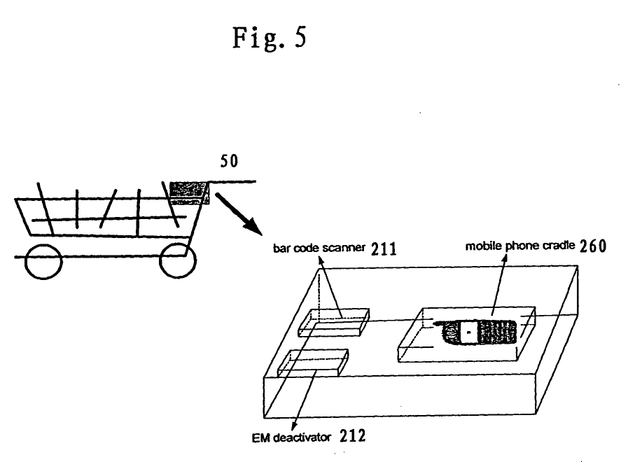

Naturally, for the sake of more security and convenience, it is possible to employ a device having the function similar to the portable terminal accessory 21 which is integrated onto a shopping cart which is provided to the customer. FIG. 5 illustrates an example of employing a device 50 which has the functions of the portable terminal accessory 21 and is integrated with the shopping cart.

As shown in FIG. 5, the device 50 having the functions of the portable terminal accessory 21 is installed solidly onto the handhold of the shopping cart. The device 50 has the functions identical to the portable terminal accessory 21, thus also includes a bar code scanner 211 and a deactivator 212. In addition, the device 50 further includes a cradle 260 for placing the customer's mobile phone, which is employed as the portable terminal 20. The cradle 260 for the mobile phone is used to fasten user's mobile phone and establish or provide a communication connection between the device 50 and the user's mobile phone. Also, it is possible to provide an additional power supply in the device 50, so that it is not necessary for the mobile phone (portable terminal 20) to power the device 50. Of course, this would prevent additional energy consumption from the battery of the portable terminal 20 and prolong its utility time. This might be useful in preventing the portable terminal 20 from shutting off during a shopping experience, because such devices in general use cells such as a rechargeable Li cell, which has a limited charge capacity and may not be fully charged when the customer wants to shop.

The description above employs the consumer's mobile phone as the portable terminal 20. However, the invention is not limited to this case. In practice, any portable device can be used to carry out the invention as long as the device can connect to the mobile banking service provider through a secure wireless link. Such devices include, for example, a PDA (Personal Digital Assistance), a handheld computer and the like which possess wireless communication capabilities.

Additionally, in the description stated above, it is described that the customer selects one article at a time and then pays for each article. Of course, the customer can select plurality of articles, then conduct the checkout process described above. In this case, the payment process for the articles which the customer purchases is conducted together for all of the articles. A receipt is then printed which lists the paid articles. Then the customer would deactivate the security strip for the paid articles one by one with the deactivator. In this way, the communication amount between the portable terminal 20 and the mobile banking service provider, and the load of the communication network can be reduced. Those of ordinary skill in the art can easily implement the process based on the disclosure in the preferred embodiment described above.

Also, it is important to note that the present invention further includes a case wherein the invention is achieved by directly or remotely supplying a software program (a program corresponding to the illustrated flow charts) that implements the functions of the aforementioned embodiments to a system or apparatus, and reading out and executing the supplied program code by a computer of that system or apparatus. In such case, the form is not limited to a program as long as the program function can be provided.

Therefore, the program code itself installed in a computer to implement the functional process of the present invention using the computer implements the present invention. That is, the present invention includes the computer program itself for implementing the functional process of the present invention.

In this case, the form of program is not particularly limited, and object code, a program to be executed by an interpreter, script data to be supplied to an OS, and the like may be used as along as they have the program function.

As a recording medium for supplying the program, for example, a floppy disk, hard disk, optical disk, magneto optical disk, MO, CD-ROM, CD-R, CD-RW, magnetic tape, nonvolatile memory card, ROM, DVD (DVD-ROM, DVD-R), and the like may be used.

As another program supply method, connection may be established to a given home page on the Internet using a browser on a client portable terminal or computer, and the computer program itself of the present invention or a file, which is compressed and includes an automatic installation function, may be downloaded from that home page to a recording medium such as nonvolatile memory and the like of the portable terminal, thus supplying the program. Also, program code that form the program of the present invention may be broken up into a plurality of files, and these files may be downloaded from different home pages. That is, the present invention may be implemented employing a web server that permits a plurality of users to download program files for implementing the functional process of the present invention using a computer or a portable terminal.

Also, a storage medium such as a CD-ROM or the like, which stores the encrypted program of the present invention, may be delivered to the user. The user in this case would have cleared a predetermined condition and be allowed to download key information that decrypts the program from a home page via the Internet, and the encrypted program may be executed using that key information to be installed on a computer or portable terminal, thus implementing the present invention.

The functions of the aforementioned embodiments may be implemented not only by executing the readout program code by the computer or the portable terminal but also by some or all of actual processing operations executed by an operating system or the like running on the computer or the portable terminal on the basis of an instruction of that program.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A mobile banking and anti-theft tag based self-service smart checkout system, said self-service smart checkout system comprising:
a mobile banking system for processing transactions by wireless communication;
a portable checkout terminal accessory for acquiring information associated with articles to be purchased; and
a portable terminal connected to the portable checkout terminal accessory for receiving said article information, and performing checkout processing with the mobile banking system by wireless communication.

2. The self-service smart checkout system according to claim 1, further comprising:
an anti-theft tag and alarm system for triggering an alarm an article leaves a predetermined store location without the article having undergone checkout processing.

3. The self-service smart checkout system according to claim 2, wherein said anti-theft tag and alarm system is one of an electromagnetic system, a radio frequency system, and an acoustic-magnetic system.

4. The self-service smart checkout system according claim 1, further comprising:
a receipt printer for printing a shopping receipt.

5. The self-service smart checkout system according to claim 4, wherein each of the articles to be purchased has a security strip having an integrated security label attached thereto; and wherein said portable terminal accessory includes a deactivator for scanning the integrated security label to deactivate the security strip in the integrated security label for a purchased article after the customer has made payment for the purchased article via the mobile banking system.

6. The self-service smart checkout system according to claim 4, wherein:
each of the articles has attached thereto an integrated security label containing a bar code; and
wherein said portable terminal accessory includes:
a processor for providing control and calculation functions to the portable terminal accessory;
a bar code scanner for reading the bar code contained in the integrated security label and sending the result to the processor;
a connector interface for connecting to a bottom connector of the portable terminal for supplying power to the portable terminal accessory and communicating with a serial port of the portable terminal; and
a controller for communicating with a running checkout control application on the portable terminal, and driving the portable terminal accessory to work with the portable terminal to complete the checkout processing.

7. The self-service smart checkout system according to claim 6, wherein the integrated security label further includes a hidden security strip; and wherein said portable terminal accessory further includes a deactivator for rescanning the integrated security label to deactivate the hidden security strip after the customer has made payment for the article to which the integrated security label is attached via the mobile banking system.

8. The self-service smart checkout system according to claim 7, wherein said portable terminal accessory further comprises:
an article information index for storing bar code and article information in a one-to-one correspondence; and
a nonvolatile memory for storing information related to articles, and for storing temporary information generated during shopping by a customer.

9. The self-service smart checkout system according to claim 1, wherein said portable terminal is a mobile phone.

10. A portable check out terminal for a retail check out system utilizing mobile banking and anti-theft tags, said portable checkout terminal comprising:
a portable checkout terminal accessory for acquiring information associated with articles to be purchased; and
a portable terminal operatively connected to said portable checkout terminal accessory for receiving the article information, and performing checkout processing with a mobile banking system by wireless communication to pay for the articles to be purchased.

11. The portable checkout terminal according to claim 10, wherein the articles to be purchased have an integrated security label having a hidden security strip attached thereto; and wherein said portable checkout terminal accessory includes a deactivator for scanning the integrated security label to deactivate the hidden security strip in the integrated security label after payment has been made for the articles to be purchased via the mobile banking system.

12. The portable checkout terminal according to claim 10, wherein each of the articles to be purchased has attached thereto an integrated security label containing a bar code; wherein said portable terminal checkout accessory further comprises:
a processor for providing control and calculation functions;
a bar code scanner for reading the bar code contained in the integrated security label and sending bar code data result to the processor;
a connector interface for connecting to a connector of said portable terminal to permit said portable terminal checkout accessory to receive power from and communicate with said portable terminal; and
a controller for communicating with a running checkout control application on said portable terminal, and driving the portable terminal checkout accessory to work with said portable terminal to complete checkout processing.

13. The portable checkout terminal according to claim 12, wherein the integrated security label includes a security strip; and
wherein said portable terminal checkout accessory further comprises a deactivator for scanning the integrated security label to deactivate the security strip in the integrated security label after payment for the article has been made via the mobile banking system.

14. The portable checkout terminal according to claim 13, wherein the portable terminal accessory further comprises:
an article information index for providing data services and storing bar code and article information; and
a nonvolatile memory for storing the article information and temporary information generated during shopping by a customer.

15. A portable terminal accessory used in conjunction with a portable terminal for conducting self-service payment process during shopping in retail store, said portable terminal accessory comprising:
a bar code scanner for reading a bar code contained in an integrated security label attached to an article available for purchase, the integrated security label also having a security strip; and
a deactivator for scanning the integrated security label and deactivating the hidden security strip if a customer has paid for the article via a wireless payment transaction.

16. A checkout method for providing a portable and secure retail checkout for the purchase of articles in a retail environment, said method comprising the steps of:
acquiring article information for one or more articles selected for purchase from the article via a portable terminal used by a customer; and
conducting checkout processing utilizing a connection between the portable terminal and a banking system via which the customer can pay for the selected articles via wireless communication without participation of an employee of the retail environment.

17. The checkout method according to claim 16, further comprising the step of:
triggering an alarm if the articles leave the retail environment without completing said step of conducting checkout processing for the articles.

18. The checkout method according to claim 17, wherein said step of conducting checkout processing further comprises deactivating a security strip attached to the selected articles via scanning after payment has been confirmed for the selected articles.

19. The checkout method according to claim 16, wherein said step of conducting checkout processing further comprises the substeps of:
scanning an integrated security label containing a bar code and security strip attached to each of the selected articles to acquire articles information; and
rescanning the integrated security label to deactivate the security strip in the integrated security label after payment has been confirmed.

20. Computer program code stored on media for a portable checkout system that permits a customer to select and pay for articles to be purchased in a retail environment without use of an employee of the retail environment, said computer readable code comprising:
first subprocesses for acquiring article information for one or more articles selected for purchase from the article via a portable terminal used by a customer; and
second subprocesses for conducting checkout processing utilizing a connection between the portable terminal and a banking system via which the customer can pay for the selected articles via wireless communication without participation of an employee of the retail environment, said second subprocesses obtaining article information via scanning an integrated security label containing a bar code and security strip attached to each of the selected articles and deactivating the integrated security label via scanning the security strip in the integrated security label after payment has been confirmed.

21. Computer program code according to claim 20, further comprising:
third subprocesses for triggering an alarm if articles are taken out of the retail environment if the integrated security label has not been scanned to deactivate the security strip.
